(19) United States
(12) Patent Application Publication
(10) Pub. No.: US 2020/0202278 A1
(43) Pub. Date: Jun. 25, 2020

(54) Methods, System and Apparatus for Compliance Metering and Reporting

(71) Applicant: Gender Fitness Pty LTD, Victoria (AU)

(72) Inventors: Ken Barton, New South Wales (AU); Andre Ong, Victoria (AU); Vivien Pine, Victoria (AU); Mark Stiebel, Victoria (AU)

(21) Appl. No.: 16/229,017

(22) Filed: Dec. 21, 2018

(51) Int. Cl. G06Q 10/06

(52) U.S. Cl. CPC G06Q 10/06393; G06Q 10/06315

(57) ABSTRACT

The present invention relates to metering and reporting on the compliance of an organisation to government, corporate and/or legal requirements by way of determining a demographic measure of an organisation/business activity, process or function wherein the business activity, process or function comprises a plurality of active participants where each active participant carries at least one uniquely identifiable mobile communications device, the method comprising the steps of:
accessing a personal organisation database in operative communication with the mobile device of each participant and extracting calendar and/or scheduling information on each participant from an email service account of respective participants from the database;
accessing centralised human resource database of demographic information on respective participants;
correlating the personal organisation database records with the demographic information;
generating a score for a participant; a meeting; a manager; a department; an organisation;
reporting the generated score corresponding to a participation metric for the business process or function based on the correlated records and information of participants;
displaying the reported metric of participants on the mobile communication devices.

### FIELD OF INVENTION

The present invention relates to the technology of business and/or organisational compliance. In particular, the invention relates to a method, system and apparatus for metering and reporting on the compliance of an organisation to government, corporate and/or legal requirements by way of determining a demographic measure of an organisation activity, process or function. It will be convenient to hereinafter describe the invention in relation to its use in metering and reporting the compliance of an organisation and/or its constituents with gender equity policies and/or objectives, however it should be appreciated that the present invention is not limited to that use, only. For example, the invention may find application in metering and reporting on compliance with a number of demographic balance requirements in corporate, government, private or educational institutions and organisations. Some examples of other demographic balance requirements may relate to age, location, ethnicity or tenure in the workplace.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

In the modern working environment, a number of human resource diversity targets are being set by individual corporate entities as well as government and university bodies in order to promote and provide career pathways with equal employment opportunities and to address issues of work/life balance. These diversity targets may also address the substantial issues of biases and inhibiting factors that may be present in and around the workplace acting against equal employment opportunity. By addressing these issues in the workplace, it is considered that wider benefits may be provided. For example, benefits may extend to individuals in their life outside the workplace as well as to the broader community and society in general. At least one of these wider benefits may involve improved economic productivity for individual enterprises and national productivity, collectively.

With respect to gender equality, it has been publicly stated that “We need more decent, powerful men to step up beside women in building a gender equal world.”¹ (emphasis added). Underlying this statement, gender inequality in the workplace is well documented and by way of example, at or around the time of the drafting of this specification, there are many statistics to prove its proliferation in Australia such as the following:
69.1% of men are employed full time compared to 40.7% of women;
The national gender pay gap between men and women is 23.1%;
The gender pay gap in ASX 200 organisations is 28.7%;
Average superannuation balances for women at retirement are 52.8% less than those for men;
Only 16.3% of CEOs and 28.5% of key management personnel are women;
1 in 4 organisations have no key management personnel who are women;
1 in 2 women reported experiencing workplace discrimination as a result of their pregnancy, parental leave or on return to work;
1 in 5 women indicated that they were made redundant, restructured, dismissed or that their contract was not renewed;
1 in 4 women were sexually harassed in the workplace between 2007 and 2012. ¹ Elizabeth Broderick, Former Australian Sex Discrimination Commissioner & Founder of the Male Champions of Change

Furthermore, it is observed that the number of female employees may typically fall below the number of male employees in positions of increasing seniority in an organisation. While there have been numerous factors identified and/or documented that contribute towards this imbalance, it is considered that to date there is no adequate solution that proves to be effective in addressing this issue. Moreover, the desire to achieve a gender balanced workforce in an organisation gets increasingly challenging moving up the organisation as the pool of female candidates for the positions of higher seniority diminishes. It is considered that in order to increase the pool of female candidates, it is essential to start by maintaining a balance of female participation in regular organisation functions and activities at all levels of the organisation.

Gender equality is now an issue that permeates beyond the work environment into being a social issue for practically all cultures and societies. As an example of the ubiquity of gender imbalance, the study and findings of Wagner et al² into the Wikipedia online encyclopedia provide a specific example of how this otherwise social issue is, in fact, a technical and scientific problem to be addressed. ² “It's a Man's Wikipedia? Assessing Gender Inequality in an Online Encyclopedia”, Association for the Advancement of Artificial Intelligence (www.aaai.org) [2015]

There are examples of tools that have been utilised in the workplace to make a positive impact on an organisation and improve its compliance with introduced norms and benchmarks of operation.

One example is the LTIRF³ standard for promoting safety in the workplace. By way of explanation, and with reference to FIGS. 1a and 1b, a lost-time injury is defined as an occurrence that resulted in a fatality, permanent disability or time lost from work of one day/shift or more. Lost-time injury frequency rates (LTIFR) are the number of lost-time injuries within a given accounting period relative to the total number of hours worked in the same accounting period. This figure is often multiplied by 1 million as lost time injuries per hour is always a very small number:

$$\frac{Number of lost time injuries in accounting period}{Total hours worked in accounting period} \times 1000000$$

LTIFR measures can be benchmarked over time and to several levels of granularity such as by industry (FIG. 1a), occupation (FIG. 1b), departmental etc. ³ Australian Standard 1885.1-1990

In practice, the LTIFR has been implemented in the following ways. (1) Many large Australian organisations are required to report their LTIFR and have standards to meet as set by the appropriate Commonwealth state and territory regulatory bodies; (2) Many organisations in high risk industries promote their LTIFR to employees, clients and the public as a measurable demonstration of their commitment to safety, often benchmarking against others at an industry (FIG. 1a) or occupation (FIG. 1b) level; and, (3) Operational and senior management often have the reduction of LTIFR as a KPI that is tied to their performance bonuses.

Through successful communication and initiatives aimed at reducing LTIFR, many industries have seen a reduction in LTIs over time as shown in FIG. 1a and FIG. 1b.

Many organisations have also used LTIFR to promote safety in the workplace. For example, the Asia Pacific Safety Manager of the Linfox logistics and supply chain company has mentioned that, by using LTIFR in parallel with Wilson Consulting Group, the following has been experienced at Linfox:
Significant improvement in safety culture
Improved buy in and ownership from senior operational leaders
Improved employee engagement
The creation of an environment conducive to change
Reduced injury frequency rates of over 90% over a six-year period

U.S. Pat. No. 6,154,753 (McFarland) describes a system and method for complying with the requirements of the ISO 9000 quality standard. The areas covered include controlled documentation, training management, meetings and reports, process improvement requests, project management, and audit management. All controlled documents have a security and revision control portion that controls the access and approval capabilities of the documents. The system is form controlled. Certain individual fields of the forms require the entry of data, and field's control are controlled by certain fields of other forms, with the fields being updated by other fields in the system, operator entry of data, and a combination of control by both the system and operator entry. The system includes an ISO matrix relating each document to an ISO clause. The system has a controlling document for each delineated activity, and all other documents relating to such activity are linked as a child of the controlling document. An audit trail is created by storing and making available previous iterations of current documents as child documents, insuring that the first issue, subsequent changes to content, movement to draft status, retrieval, and reissue are available for auditing the activities of the business. Accordingly, McFarland is directed to an organisation's compliance with quality standards for its products and services per se.

U.S. Pat. No. 7,298,930 (Erol et al) describes a meeting recorder that captures multimodal information of a meeting. Subsequent analysis of the information produces scores indicative of visually and aurally significant events that can help identify significant segments of the meeting recording. Textual analysis can enhance searching for significant meeting segments and otherwise enhance the presentation of the meeting segments.

US patent application publication No. 2005/0086540 (Gunter et al) describes a system for improving the security of information and documentation to be disseminated in business meeting forums. The method and system of Gunter et al automatically generates a list of participants physically present at a meeting and distributes permission to the participants. Identity and key information is collected from the participants during the meeting using at least one personal area network. The identity and key information is stored on a delegation device. Permission to access the services is distributed to the participants over at least one personal area network using the delegation device. The delegation device may include an access control matrix or moveable icons for organizing and distributing participant and permission information.

US patent application publication No. 2018/0144427 (Ebesu) addresses problems associated with improving the efficiency or safety of workers who work in a shop floor such as a warehouse and a factory. Ebesu discloses a worker data detection system, a terminal device, and a method for detecting worker data in which the worker data detection system and the terminal device include a memory and circuitry. The circuitry obtains data of at least one worker, extracts load data of the worker from the data of the worker to accumulate the load data of the worker over time in the memory, and calculates a cumulative load on the worker over time using the load data accumulated in the memory. Essentially, Ebesu provides a system to track a physical effort required for a worker to move a load.

US patent application publication No. 2004/015371 (Thomas et al) provides a method and system of managing recruitment data utilising an online application process that prohibits submission of a job application unless the applicant selects one or more available jobs. The applicant is also required to submit gender and ethnicity information. The applicant's information is stored in a database where it is related to jobs or job groups so that the employer can create a profile of the gender, ethnicity, and optionally other applicant data for applicants who apply for specified jobs or job groups. Preferably, the system also allows the employer to track similar information for new hires and thus profile an applicant pool and compare it to a profile of actual hires. However, Thomas et al does not address the issues involved with determining the compliance of an organisation and/or addressing imbalances in demographic measures.

US patent application publication No. 2017/032248 (Dotan-Cohen et al) discloses an event tracker which detects instances of events of a user and an activity analyser that detects instances of activities of the user based at least in part on sensor data. The activity analyser identifies candidate activities for each of the instances of the events and detects one or more patterns of user behaviour of the user corresponding to a designated activity of the candidate activities from the instances of the events. The activity analyser further predicts values of semantic characteristics of the designated activity from the one or more patterns of user behaviour. Further, the activity analyser identifies an instance of the designated activity as a practiced activity using the predicted values of the semantic characteristics and actual values of the semantic characteristics of the instance of the designated activity in an activity model that represents the designated activity. Personalized content is provided to the user based on the identified practiced activity. Effectively, Dotan-Cohen et al provides a system for tracking activity of customers using sensors along with infrastructure to collect the data. A vast amount of data is collected without a focus on the individual and their attributes to address the compliance of an organisation to demographic criteria. In contrast, the system is directed to providing a personalisation service, when to deliver that service, based on the pattern of individual's previous activity.

US patent application publication No. 2018/082258 (Mather et al) addresses the inherent human biases related to hiring processes and these are mediated using automated computer-based systems. Computer executed logic is configured to detect and compensate for, for example, cultural, gender, and/or racial biases. Specific applications include, job descriptions, review of resumes and interviews. The system analyses bias that is due to the content of resumes when hiring employees. The input for the analysis comprises job candidates providing answers to questions and then these are rated by the interviewer.

US patent application publication No. 2016/055457 (Mather et al) is a related disclosure to the above reference and provides a system that conducts an analysis of the content of resumes to remove words that may encourage unconscious bias. The process is also applied to advertisements for vacant positions.

US patent application publication No. 2018/089628 (Mather et al) discloses a mechanism of reviewing resume content looking for bias on the words used in a resume. Candidates are ranked based on a subjective weighting on what constitutes bias language. Essentially the system is looking for gender bias in position description.

US patent application publication No. 2018/089629 (Mather et al) is another related reference to the above that provides a computer-mediated tool for determining promotions. Again, this system is directed at analysing words or language used in the content of resumes, interviews or performances reviews.

With the above in mind, it is notable that there are currently limited objective measures of demographic (e.g. gender, ethnicity etc.) balance in business processes and functions including, for example, in business meetings. As a result, there could potentially be instances of demographic inequality in the workplace that could otherwise be kept in check. Furthermore, with respect to demographic balance, there are currently limited objective measures of business meeting quality or more generally business process quality. As a result, for example, there could potentially be many meetings held that are of poor quality.

Another problem that has been identified is that whilst initiatives for a flexible, equitable and safe workplace are laudable in the eyes of most employers and employees, a lack of technology that can reliably implement these initiatives has been cited as a large factor in measured dissatisfaction in flexible working arrangements being adopted across an increasing number of workplaces.

The preceding discussion of background art is intended to facilitate an understanding of the present invention only. The discussion is not an acknowledgement or admission that any of the material referred to is or was part of the common general knowledge as at the priority date of the application.

### SUMMARY OF INVENTION

It is an object of the embodiments described herein to overcome or alleviate at least one of the above noted drawbacks of related art systems or to at least provide a useful alternative to related art systems.

In accordance with one aspect of embodiments of the present invention, there is provided a method of metering and reporting on the compliance of an organisation to government, corporate and/or legal requirements by way of determining a demographic measure of an organisation/business activity, process or function wherein the business activity, process or function comprises a plurality of active participants where each active participant carries at least one uniquely identifiable mobile communications device, the method comprising the steps of:

accessing a personal organisation database that is in operative communication with the mobile communications device of at least one or each participant and extracting calendar and/or scheduling information on at least one or each participant from an email service account of respective participants from the database;

accessing a centralised human resource database of demographic information on respective participants;

correlating the personal organisation database records with the demographic information;

generating a score for one or a combination of a participant; a meeting; a manager; a department; an organisation;

reporting the generated score corresponding to a participation metric for the business process or function based on the correlated records and information of each participant;

displaying the reported metric of one or a combination of participants on at least one of the mobile communication devices.

In accordance with another aspect of embodiments disclosed herein there is provided a method of metering and reporting on the demographic balance of an organisation, the method comprising:

extracting electronic mail service account information of the organisation;

extracting calendar and/or scheduling information from the electronic mail service;

extracting personal demographic information from a HR database associated with the organisation;

extracting survey data from end point users associated with the extracted personal demographic information;

processing the extracted information

storing the processed information in a first data store

communicating one or a combination of the processed and stored information with at least one or more of the end point users via at least one API;

further processing the communicated information by determining one or a combination of scores;

notifying end point terminals and/or end point users of one or a combination of the determined scores.

In methods as disclosed herein one or more of the extracted electronic mail service account information and the calendar and/or scheduling information may correspond to a selected number of individuals employed with the organisation.

In yet another aspect of embodiments disclosed herein there is provided apparatus adapted to meter and report on the demographic balance of an organisation, said apparatus comprising:

processor means adapted to operate in accordance with a predetermined instruction set,

said apparatus, in conjunction with said instruction set, being adapted to perform one or a combination of the method steps as disclosed herein.

In still another aspect of embodiments disclosed herein there is provided a computer program product comprising:

a computer usable medium having computer readable program code and computer readable system code embodied on said medium for metering and reporting on the demographic balance of an organisation within a data processing system, said computer program product comprising:

computer readable code within said computer usable medium for performing one or a combination of the method steps as disclosed herein.

Other aspects and preferred forms are disclosed in the specification and/or defined in the appended claims, forming a part of the description of the invention.

In essence, embodiments of the present invention stem from the realization that while the effectiveness of business meetings are often questioned in general, there is limited useful ways of measuring the effectiveness of a meeting, both independently and on average across a department, business, or industry. Similarly, while there is evidence pointing towards demographic imbalance in general, there are limited effective ways of measuring the demographic balance in a meeting, both independently and on average across a department, business, or industry. In order to encourage an increase of participation in business activities and functions, it has been realised that this may be achieved by assessing and reporting on the balance in meetings. It has also been realised that any method of monitoring needs to be non-intrusive so as not to interfere with current work practices. It also must not impose additional overheads or workload in order to gather the data necessary for balance assessment to encourage adoption. Moreover, it has been realised that data can be transparently extracted from calendar management systems and combined with data extracted from employee management systems to produce a new tool for organisational management utilising an additional dimension of data in the form of employee/participant balance statistics.

Embodiments of the present invention provide the following advantages:
With gender and participation statistics incorporated into regular organisation meeting activities, an organisation may gain a heightened level of awareness of the balance of gender in its functions and/or activities;
An organisation can effectively utilise gender balance awareness as a tool to address the issue of gender inequality through gradual change in behaviour and maintain an equal mix of female and male employees across all levels of the organisation. A constant awareness and striving to maintain balance and quality of participation across genders collectively brought about the coining of the term ‘gender fitness’ as used herein;
Attraction and retention of targeted employee make-up of the workplace is achieved, for example, increased female representation into a business or organisation;
Assistance with the development of talent programs that have veracity, for example, executive and mid-level female participation in formal programs;
Improved engagement as measured by employee engagement surveys;
Contributing to reliable metrics that highlight the impact of flexible arrangements such as parental leave on the individual and the organization;
Efficient and improved promotion, for example, addressing executive and mid-level female representation;
A substantial contribution to flexible work;
Assisting in the eliminating of everyday discrimination, eg sexism, from the workplace;
Promoting personal leadership at all levels of the organisation;
Improved communication within and external to an organisation;
All of the above, combines to impact upon not only an organisation, but, when correctly implemented in other organisations, also combines to impact upon more broadly an industry, as a whole.

Furthermore, by using gender equity and balance as an exemplary measure, it is recognised by the inventor that, from the viewpoint of data usage the following advantages and benefits may be derived from embodiments of the present invention:
awareness may be raised of the underlying data regarding gender diversity in meetings, which previously had been unexplored. Improvements in gender balance of meetings may be provided by being able to trace the gender diversity of meetings prior to the implementation of embodiments of the present invention and comparing pre-awareness and post trends.
Providing a simple means of measuring meeting feedback in terms of inclusiveness. This provides insight as to how meetings are being conducted in terms of allowing all attendees an opportunity to contribute and gauge whether the attendees feel that their contribution is valued. This will provide a sense of whether there is a culture of inclusiveness during meetings at an individual, department, business unit and company level. Providing visibility of these statistics may then drive changes which can be tracked over time. Providing visibility of the facts eliminates preconceptions and allows change to occur based on reality.
Enable meaningful benchmarking across departments and business units on their ‘Gender Fitness’ (ie gender balance) scores. Eventually this can be made to form part of KPIs to be reported on regularly. These statistics can also be used to gamify implementations of the present invention in the form of applications (Apps) to add a sense of competition amongst individuals and departments. Through analytics, algorithms and machine learning it can be determined what works and doesn't based on individuals and therefore drive a better performance overall. The application of analytics, algorithms and machine learning will assist the organisation to understand the following outcomes (1) Expose the effect(s) that poor gender balance in teams and departments has on employee retention, (2) Predict the effect of an employee moving from a highly gender fit team into a team who has a poor gender fitness level. For example, will the new team member maintain their own fitness level, adopt the fitness levels or their new team or raise the fitness level of their new team and, (3) Track the effectiveness of short, mid and long term environmental changes on gender fitness.
Detailed analysis may be provided on meeting feedback such as percentage of meetings responded in the last 7 or 14 days, and since launch, percentage of meetings with positive/negative feedback, gender of the respondents, etc. This provides insights as to behavioral change over time. By comparing different points in time it will be possible to link to external event(s) which impact results.
Detailed analysis on meeting gender may be provided, i.e., percentage of meetings that are perfectly gender balanced, single gender and for the rest that fall in between, the degree of imbalance. The highlight on single gender meetings and meetings which are severely imbalanced will assist the organisation to address the imbalance. Real time analytics and feedback will enable immediate change with the intent of rectifying behavior when it occurs.
An easy to understand way of scoring a behavioral trait that is closely related to gender mix and inclusiveness at meetings. Benchmarks can then be set and compared across companies and industries. Addresses the vagueness in the topic of gender fitness at the workplace and provides a goalpost for measuring behavior changes.
Actionable insights may be provided. Embodiments of the invention may provide the foundation for expanding with qualitative questions relating to corporate meeting and gender efficiency, measure the loss/gain caused by a finding and tying it to a business impact. Through this analysis, it may be possible to begin to create hypotheses to answer specific business questions and test hypotheses to gain actionable insights. This is to prove the point that once an easy way to measure actions and report on the results is attached, it becomes a powerful agent of change.
Meeting organisers may be alerted in real time when the meeting is organised regarding their meeting gender split and enable them to address and rectify if needed prior to the meeting commencement.
Use algorithms and machine learning to discover trends at both individual level and organization wide which can influence changes in culture.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1a is a table extract sourced from Safe Work Australia of LTIFR by Industry;

FIG. 1b is a table extract sourced from Safe Work Australia of LTIFR by Occupation;

FIG. 2 is a system diagram showing an overview of a compliance metering and reporting system in accordance with an exemplary embodiment of the present invention;

FIG. 3 is a block system diagram showing an overview of a compliance metering and reporting system in accordance with another preferred embodiment of the present invention;

FIG. 4 is a block diagram showing components of an exemplary directory service reader for use in accordance with an embodiment of the present invention;

FIG. 5 is a block diagram showing components of an exchange reader for use in accordance with an embodiment of the present invention;

FIG. 6 is a block diagram showing components of an exemplary proprietary HR database information reader for use in accordance with an embodiment of the present invention;

FIG. 7 is a block diagram showing components of a data stream processor for use in accordance with an embodiment of the present invention;

FIG. 8 is a block diagram showing components of an unaudited data store in accordance with an embodiment of the present invention;

FIG. 9 is a block diagram showing components of an ETL (Extract, Transform and Load) process in accordance with an embodiment of the present invention;

FIG. 10 is a block diagram showing components of an audited data store in accordance with an embodiment of the present invention;

FIG. 11 is a block diagram showing components of an employment details API for use in accordance with an embodiment of the present invention;

FIG. 12 is a block diagram showing components of a metering and reporting process implemented by API in accordance with an embodiment of the present invention;

FIG. 13 is a block diagram showing components of a database for metered results in accordance with an embodiment of the present invention;

FIG. 14 is a block diagram showing components of a user interface for a metering and reporting process in accordance with an embodiment of the present invention;

FIG. 15 is a block diagram showing components of an administration interface for a metering and reporting process in accordance with an embodiment of the present invention;

FIG. 16 is a block system diagram showing an overview of a compliance metering and reporting system in accordance with another preferred embodiment of the present invention;

FIG. 17 is a block diagram showing components of an exemplary directory service reader and its integration into the compliance metering and reporting system of FIG. 16;

FIG. 18 is a block diagram showing components of an exchange reader and its integration into the compliance metering and reporting system of FIG. 16;

FIG. 19 is a block diagram showing components of an exemplary proprietary HR database information reader and its integration into the compliance metering and reporting system of FIG. 16;

FIG. 20 is a block diagram showing components of a data store and its integration into the compliance metering and reporting system of FIG. 16;

FIG. 21 is a block diagram showing back end components of an exemplary reporting means that interfaces with remote or external devices and/or terminals in accordance with a preferred embodiment of the present invention;

FIG. 22 is a block diagram showing front end components of exemplary user interfaces in accordance with a preferred embodiment of the present invention;

FIG. 23 is a block diagram showing an authentication mechanism in accordance with a preferred embodiment of the present invention;

FIG. 24 is an exemplary App wireframe of a user interface in accordance with an embodiment of the present invention;

FIG. 25 is another exemplary App wireframe of a user interface in accordance with an embodiment of the present invention;

FIG. 26 is an exemplary App wireframe of a user display in accordance with an embodiment of the present invention;

FIG. 27 is another exemplary App wireframe of a user display in accordance with an embodiment of the present invention;

FIG. 28 is a further exemplary App wireframe of a user display in accordance with an embodiment of the present invention.

### DETAILED DESCRIPTION

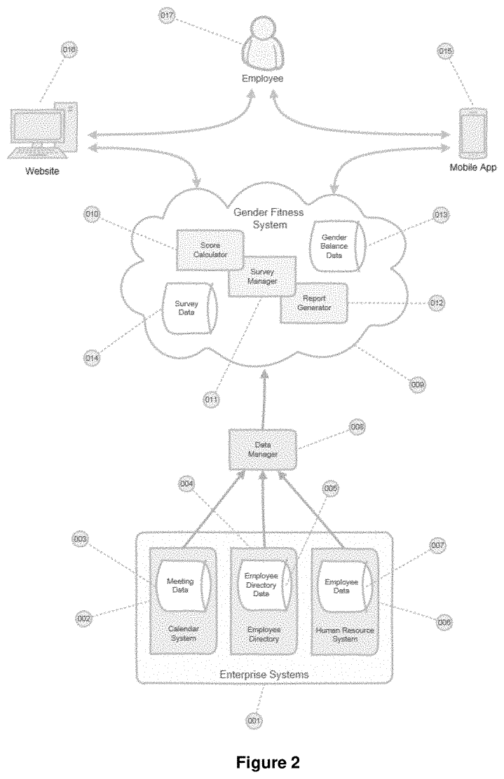

An exemplary preferred embodiment of the invention is shown in system overview in FIG. 2 and is directed to the creation of a platform that monitors or determines the demographic composition, in particular gender, of participants in business functions or activities and provides an objective and standardised score (or set of scores) indicative of the quality or effectiveness of the business function or activity as well as a score (or set of scores) for the business function organiser, the business function organiser's department and the broader business in general, which is indicative of a level of compliance of these entities to benchmarked quantitative measures, with the intent of enabling the improvement of demographic balance in the workplace over time.

One of these regular organisation functions and/or activities are meetings. Meetings are typically organised by meeting organisers with a target list of participants in mind. It has been observed that the balance of gender is usually not a consideration when a meeting is called. Accordingly, a realisation of the inventor is that if there is already an imbalance in female participation in meetings at lower levels of the organisation, the opportunities for female employees to contribute and demonstrate their abilities will already be limited at that level. Further, with limited opportunities, the numbers of female candidates are likely to be constrained moving up the ranks of the organisation.

It will be convenient to hereinafter describe an embodiment of the invention in relation to a method, system and apparatus using email account and calendar information in conjunction with HR management system information to meter and report on the compliance of a corporation and/or its constituent department's or its personnel with gender equity policies.

In order to encourage an increase of female participation in meetings, it has been realised that this may be achieved by assessing and reporting on the balance in gender in meetings. It has also been realised that any method of monitoring needs to be non-intrusive so as not to interfere with current meeting practices. It also must not impose additional overheads or workload in order to gather the data necessary for gender balance assessment to encourage adoption. Moreover, it has been realised that data can be transparently extracted from calendar management systems and combined with data extracted from employee management systems to produce a new tool for organisational management utilising an additional dimension of data in the form of gender balance statistics.

Additionally, it has been determined that besides a balance in gender, it is desirable for the quality of participation to be assessed to ascertain equality and opportunities to contribute for all meeting participants. Accordingly, a method of assessing participation through meeting surveys is incorporated into the statistics reported back to the meeting organisers and/or business managers.

With reference to FIG. 2, a preferred embodiment of the present invention provides a method and apparatus that facilitates gender equality in an organisation by consistently bringing awareness to meeting hosts and organisers. Awareness is raised by deriving a metric of the balance of gender in everyday meeting activities through the combination of meeting scheduler data and employee data extracted from organisational calendaring and human resources management systems. A gender balance metric for each meeting organiser is evaluated using an algorithm that aggregates meeting data and mix of participant genders of meetings conducted. A further dimension of qualitative data for each meeting is generated through surveys filled out by meeting participants. The combined gender balance metric and qualitative score of the meeting surveys are used to determine a metered assessment, or as referred to herein, the overall gender fitness score of meeting organisers. The gender fitness score is presented to meeting organisers as a measurable indicator of the balance and quality of meetings conducted by them and serves as a guide to encourage adjusting their practice towards a gender balanced workplace providing equal opportunities to all genders.

### Preferred System Components

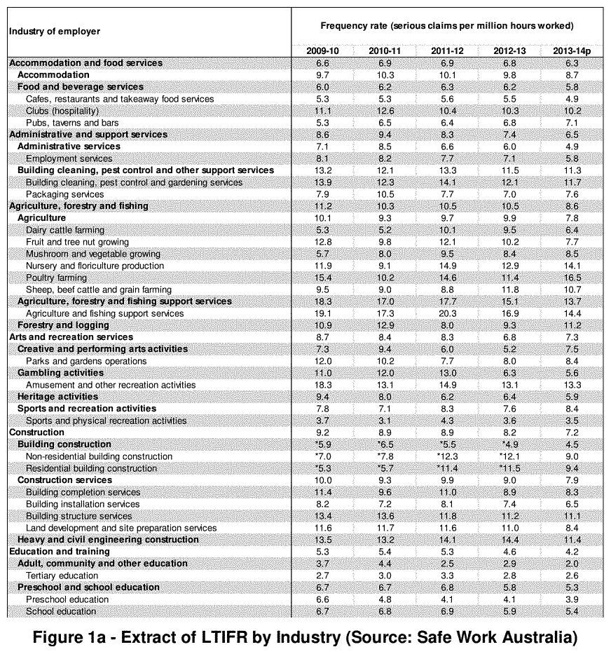

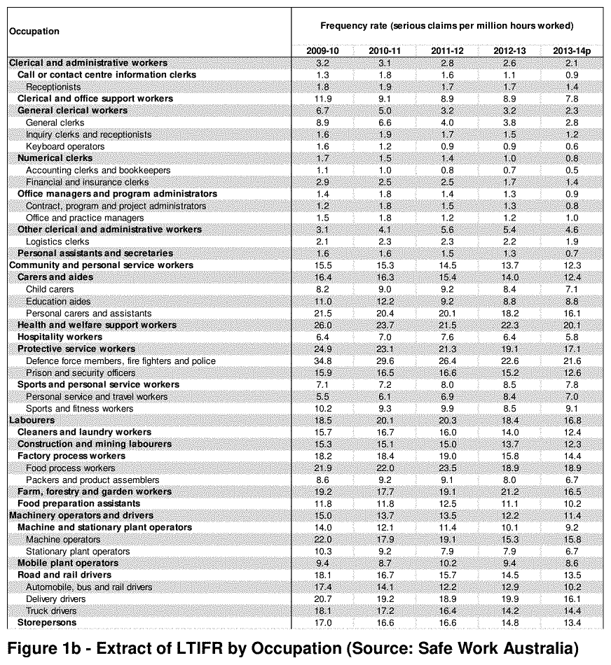

The following systems components are utilised by a preferred embodiment of the present invention. It is to be noted that when using the term ‘employee’, the description herein is referring to full or part time employees as well as contractors recorded in existing workplace enterprise systems. The system components of FIG. 1 are enumerated as follows.

### (001) Enterprise Systems

Pre-existing enterprise systems denoted generally as (001) in FIG. 2, are those systems that an organisation would reasonably be expected to have in place to manage the everyday aspects of running an organisation. In this instance, we are including a Calendar System (002), an Employee Directory (004) and a Human Resource System (008). The system of the present invention looks to these existing systems of an organisation to draw relevant organisational data for use in determining the gender fitness of the organisation.

### (002) Calendar System

A calendar management system denoted as (002) in FIG. 2, which is usually a component of a larger email system may be classed as an existing enterprise system (001). The gender fitness system denoted as (009) in FIG. 2, requires and/or relies on an organisation's calendar system (002) to provide meeting data. On creation of a new meeting, the calendar system (002) pushes new meeting data to a data manager (008).

### (003) Meeting Data

Meeting data forms a component of a calendar system (002). It is expected that the data extracted from meeting data (003) will be sufficient to identify all employees associated with a meeting when compared to the employee directory data (005) and employee data (007).

Extracted data includes:
Meeting organiser email address.
Date and time meeting will start.
Date and time meeting will end.
Meeting subject.
List of meeting invitees email addresses.
Meeting privacy status.

If a new meeting is created and its sensitivity level is set to private, that meeting will be ignored. If an existing meeting's sensitivity level is updated to private that meeting data will be retrieved.

### (004) Employee Directory

An employee directory is usually classed as an pre-existing enterprise system (001). The gender fitness system (009) requires an organisation's employee directory (004) to be able to identify relevant employees. In this instance, the data manager (008) is responsible for identifying and validating the employee directory data (005) managed by the employee directory (004).

### (005) Employee Directory Data

Employee directory data (005) is a component of the employee directory (004). It is expected that the employee related data held within the employee directory data component (005) will be sufficient to validate the meeting data (003) previously received by the data manager (008). The data manager (008) will use the employee's unique organisational identifier to locate and validate employees associated with specific meetings.

Employee data includes:
Account status to ensure the employee is active within the organisation.
Primary email address.

### (006) Human Resource System

A human resource system (006) is usually classed as an existing enterprise system (001). The gender fitness system (009) requires an organisation's human resource system (006) to be able to provide relevant employee characteristic data. In this instance, the data manager (008) is responsible for extracting the employee data (007) managed by the human resource system (006).

### (007) Employee Data

Employee data (007) is a component of a human resource system (006). It is expected that the employee characteristic data held within employee data component will be sufficient to validate the meeting data (003) previously received by the data manager (008) from the calendar system (002). The data manager (008) will use the employee's unique organisational identifier to locate and extract employee characteristic data.

Employee data includes:
Employee identification
Employee full name
Employee title/position
Employee hierarchy/level
Employee department
Employee manager
Gender:
   Male, Female or Other

### (008) Data Manager

The data manager's role is to receive and validate the meeting data from the calendar system (002). The data manager (008) will use the employee's unique organisational identifier to locate and validate employees associated to meetings in the employee directory (005) as well as locate and extract employee characteristic data from the human resource system (006).

Employee directory validation criteria comprises the following;
Organiser must be an active employee of the organisation.
Organiser must have at least one valid organisational email address.
Organiser must be classed as an employee e.g. not a meeting room.
Invitees must be employees of the organisation.
Invitees must have at least one valid organisational email address.

Once the data manager (008) has validated the meeting data (003) and retrieved the additional employee characteristic data the validated data is sent to the gender fitness system (009) to be stored with other gender balance data (013). If a meeting's sensitivity level has been updated to private the existing meeting stored within the gender balance data (013) will be marked as invalid.

### (009) Gender Fitness System

The gender fitness system is designed to manage all components required to execute the improved metering and reporting tool of the present invention. Components include gender balance data (013), survey data (014), score calculator (010) and survey manager (011). The reports generator (012) is an ancillary component deigned to deliver additional organisational benefits. The data manager (008) manages the communication between the gender fitness system (009) and the existing enterprise systems (001).

### (010) Score Calculator

The score calculator calculates and returns an individual employee's gender fitness score by evaluating the data stored within the gender balance data (013). The calculation is completed in real time ensuring the employee's score takes all relevant, up-to-date meeting data and survey answers into consideration. The score calculator can be called upon by gender fitness applications either mobile or web based. Reference is made to the below section on Gender Fitness Score

Algorithm for detailed score calculation.

### (011) Survey Manager

The survey manager retrieves the meeting survey questions from the survey data (014). The date and time a meeting concludes is retrieved from the gender balance data (013). The survey questions are made available to relevant attendees after a meeting has concluded via the mobile app (015) or the website (016). It is the responsibility of the attendee to complete the meeting survey. Ideally, the survey questions should be made available to be completed by an attendee via an app on a mobile device to ensure a timely response. For convenience, the survey questions should also be made available on or via the gender fitness website.

Question attributes comprise:
Question description.
Answer:
   Yes or No, Slider 1 to 5
Weighting:
   Total question weighting should add up to %100.
   Questions weighting is arbitrary; however, they should be based on individual organisational requirements and best practice.
Start date.
End date.

### (012) Report Generator

The report generator is an ancillary component deigned to deliver additional organisational benefits by drawing on the gender balance data (013) and the survey data (014). Reports can be distributed via the mobile app (015), the website (016), an email or other appropriate means.

Anticipated reports may comprise:
Individual, department or organisational-wide leader board.
Departmental and organisational-wide gender fitness scores.
Historical trends across departments and the organisation.
Identification of strong bias either positive or negative which should be addressed at the managerial level.
Ad hoc.

With regard to historical trends, by way of example, gender diversity of organisational meetings may be traced prior to implementing an embodiment of the invention through the manual extraction of historical meeting data from email systems combined with historical employee data obtained from HR systems, which will provide an historical view of an organisation's gender balance levels. Depending on the results it may be possible to surmise the potential value of implementing an embodiment of the invention.

### (013) Gender Balance Data

The gender balance data component contains all data relevant to calculate an employee's gender fitness score. The gender balance data is made up of meeting and employee data supplied by to the gender fitness system (009) by the data manager (008). The gender fitness data also holds the results of surveys completed via the mobile app (015) and the website (016).

### (014) Survey Data

The survey data component contains the survey questions and their attributes. The survey manager (011) retrieves the survey questions from survey data when requested by the mobile app (015) and the website (016). The employee response to the survey questions, however, are stored in the gender balance data (013).

### (015) Mobile App

The mobile application allows an employee to view their gender fitness score calculated by the score calculator (010). The mobile app also allows an employee to respond to surveys delivered by the survey manager (011) that relate to meetings the employee has attended. Ideally, the mobile application should be made available as the primary gender fitness interface for an employee to ensure meeting survey questions are answered in a timely and convenient fashion.

### (016) Website

The website allows an employee to view their gender fitness score calculated by the score calculator (010). The website also allows an employee to respond to surveys identified by the survey manager (011) that relate to meetings the employee has attended. The website should be made available for the convenience of the employee as an ancillary gender fitness interface.

### (017) Employee

The employee interacts with the gender fitness system (009) via the mobile app (015) as well as the website (016). The term employee refers to full or part time employees as well as contractors each of which may have their relevant data found in existing enterprise systems.

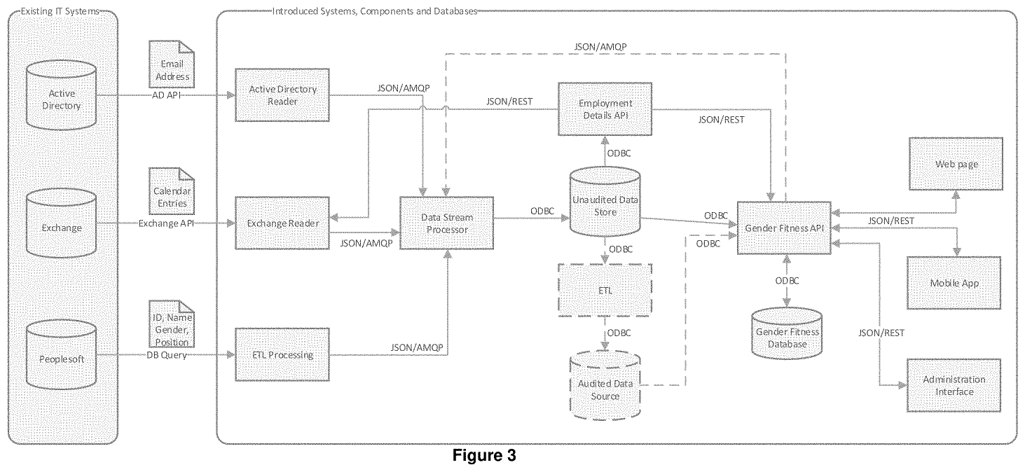

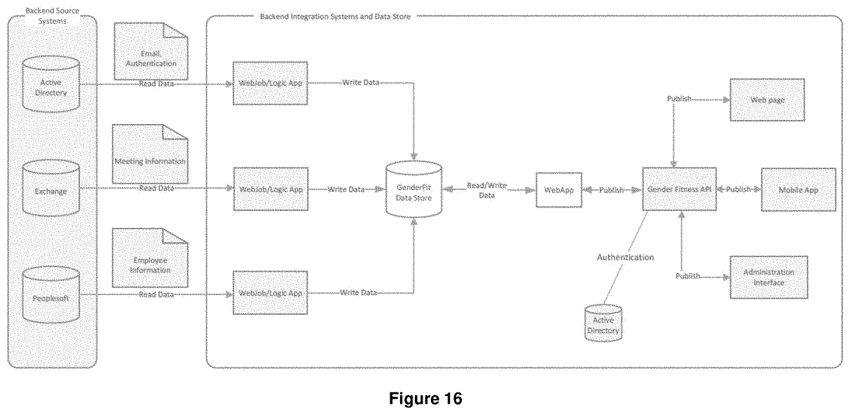

Another embodiment of the invention is illustrated in FIGS. 3 to 23 and is comprised of three components—a backend system, algorithms and a mobile application. The backend system extracts, processes and stores information that feeds into the algorithm and mobile application. It is composed of several input systems: an Identity Management System—to extract email account details, an Email Calendar System—to extract calendar details, an HR Management System—to extract personal demographic details and Survey Feedback—to extract meeting quality details. The data from these input systems are processed and placed in a data storage system, which then feeds through to the central API and Mobile Application. Algorithms are then used to process the input data on demographic composition and meeting quality, to generate one or multiple scores. Scores will be granted at three levels: At the meeting organiser level (e.g. John Smith has a Gender Fitness score of 3/10), at the department level (e.g. Marketing has a Gender Fitness score of 7/10) and at the business level (e.g. Business A has a Gender Fitness score of 6/10). Scores will be made visible on a mobile application, which is also used to input answers to meeting quality survey questions.

By having an objective and standardised score allocated to all employees, personnel can review the score and will be able to take it into account in subsequent meetings. Similarly, by having scores at the department and business level, hiring managers can review the score of each department and factor this into meeting and hiring decisions. This will improve demographic balance over time, particularly if the score is also integrated into the performance indicators of employees, departments and businesses. As noted, a preferred embodiment of this invention is to measure and promote gender balance in the workplace. However, through some modification, further embodiments of the invention also measure and promote other imbalances such as ethnicity, age, tenure, preferences etc. The front end of embodiments, currently described as a mobile application, may also exist in other forms such as a website.

As a platform which monitors the composition of business meetings and records their quality, the system collates and/or correlates information from a combination of systems (identity management systems, email/calendar systems and HR management systems) as well as survey feedback to generate a score output via an app to gauge business meeting quality and composition.

### Purpose and Applications

The primary purpose of embodiments in their preferred form is to provide a standardised tool for measuring the gender composition of business meetings, as well as business meeting quality amongst all participants, with the intention that this tool can be used to foster improved gender balance in the workplace.

The same backend system can be used to support other front-end embodiments beyond gender balance, for example to measure and improve ethnic balance. In this respect, embodiments may include the measurement and reporting of the following but are not limited to:
Gender
Ethnicity
Age
Workplace seniority
Workplace department
Location of residence
Distance from work

It is envisaged that an organisation may use embodiments of the invention as a tool to create a positive impact on demographic balance, in a similar way that the LTIFR standard has been used to promote safety in the workplace.

### Components

The backend system, described in more detail hereinafter, generally conforms to the following:
The backend system extracts, processes and stores information that feeds into the central measurement algorithm and mobile application
It is composed of several input systems
   Identity Management System—to extract email account details
   Email Calendar System—to extract calendar details
   HR Management System—to extract personal demographic details
   Survey Feedback—to extract meeting quality details
The data from these input systems are processed and placed in a data storage system, the data is exposed via a API which is then consumed by the mobile application.

Algorithms utilised in preferred embodiments may conform to:
Algorithms are used to process input data on composition and meeting quality, to generate one or multiple scores for reporting;
Exact algorithms used are to be determined and subject to change
Scores will be applied on three levels and the resultant score may be referenced in this embodiment as a “gender fitness” level/score:
   At the employee level (e.g. John Smith has a Gender Fitness score of 3/10)
   At the department level (e.g. Marketing has a Gender Fitness score of 7/10)
   At the business level (e.g. Organisation has a Gender Fitness score of 6/10)

Mobile Application
A mobile application is provided for several purposes
   As a means to input meeting survey questions after every meeting
   As a means to view a user's ‘gender fitness’ score and compare it to his or her departmental and whole of business peers
   As a means to track increases and decreases of a user's ‘gender fitness’ score

### An Overview of an Example Working System

The following steps are followed in a typical use of a preferred embodiment of the invention:
Employee's set up meetings as per normal business operations
Participants indicate whether they accept or decline the meeting
Several minutes before the meeting is due to start, all ‘accepted’ participants with the app installed on their mobile device will receive a notification to answer a number of survey questions. For example (and to be finalised):
   Did you attend? (Yes/No)
   My contribution to this meeting (Out of five)
   Overall meeting effectiveness (Out of five)
The prompt will also feature a Confirm or Snooze button
   If the participant hits Confirm, survey data will be sent to the database
   If the participant hits Snooze, the participant will receive the same notification at a later time
The meeting is held
‘Accepted’ participants with the app will answer the survey questions
The backend system will assess participant demographics, whether or not they attended the meeting and survey responses to generate scores for the meeting
The meeting organiser can view his or her ‘gender fitness’ score, how it has changed historically and how he or she ranks compared to his peers, his department and his organisation
The meeting organisers score can then be combined with other organisers scores within the same department to calculate their departments overall score. Further, the department's score can then be combined with all participating department's scores to derive the organisations score.
The meeting organiser may take into account his or her score for subsequent meeting requests, particularly if a ‘gender fitness’ score target is incorporated into the organiser's performance indicators

### Gender Fitness Score

In an exemplary embodiment of the invention a ‘gender fitness score’ may be acquired as a measure of gender balance in an organisation. By way of example, the gender fitness score of each meeting may be obtained, as follows. The score takes into consideration both the gender of the invitees and survey responses. The two parts combined are used to portray a score which measures the gender fitness or a metered demographic balance of the collaboration.

According to a preferred calculation,

Gender Fitness Score=Gender Ratio Score+Survey Answers, where each is composed

Maximum 100 points=Maximum 50 Points+Maximum 50 Points.

### Gender Ratio Score

The Gender Ratio Score is calculated as follows:

Based on data extracted, for example, from MS Exchange and PeopleSoft™ as an example HR management system, this score is the difference from and balanced 50-50 split of females to males invited and that have attended the meeting. Having too many males in the meetings will result in a lower gender ratio score as does having too many females in the meeting. Graphically, this can be represented as below.

The present example measurement also attends with the gender group of ‘Other’ determined by genders other than strictly male or female. In this respect, the gender group of ‘Other’ is equally divided between females and males. By way of example, if there are 4 females, 2 males and 1 of ‘other’ gender invited to a meeting, the calculation is:

Females=Females+½Other=4.5

Males=Males+½Other=2.5

### Survey Answers

Based on predetermined survey questions asked and answered, each question has a favourable/unfavourable response or scale. Y(Yes)/N(No) questions will be allocated a value of one for ‘Yes’ and zero for ‘No’. Scale questions will be based on the number answered, where zero is unfavourable, and four is favourable. Each question has a weighting, the sum of all questions weighting equals 100%. The weighting percentage allocated to each question is based on the organisation's desired outcome when considering that organisation's perceived shortcomings in the area of gender equality/balance or, gender fitness.

An example calculation of a ‘gender fitness score’ for a business meeting follows:

### Example 1

Meeting with the following composition of participants:

| | |
|---|---|
| Females | 4 |
| Male | 2 |
| Other | 1 |
| Total Team Members | 7 |

Gender Ratio Score calculation:

### Calculated Females=4.5

### Calculated Males=2.5

Calculate the variance from 50% equality.
Percent of one gender by total (4.5/7)*100=64.28
Round to return a full number round (64.28,0)=64
Calculate variance from 50 (balance) IF (64−50>0) then (64−50) else (50−64)=14
Convert the value out of 50 as the maximum score is 50.

50−14=36

### Conclusion: Gender Ratio Score=36

### Survey Answers Calculation:

### Survey Questions:

| Question # | Question | # Options | Values | Weighting | Start Date | End Date |
|---|---|---|---|---|---|---|
| 1 | Was I given the | 2 | 1 = Yes | 50% | 1 Jan. 2017 | 18 Apr. 2017 |
| | opportunity to | | 0 = No | | | |
| | contribute? | | | | | |
| 2 | Was my | 2 | 1 = Yes | 50% | 1 Jan. 2017 | 18 Apr. 2017 |
| | contribution | | 0 = No | | | |
| | respected? | | | | | |

For one meeting with 7 invitees which all answered the questions the results were as follows:

| | Q1 | Q2 |
|---|---|---|
| Invitees 1 | 1 | 1 |
| Invitees 2 | 1 | 0 |
| Invitees 3 | 1 | 1 |
| Invitees 4 | 0 | 1 |
| Invitees 5 | 0 | 1 |
| Invitee 6 | 1 | 0 |
| Invitee 7 | 1 | 0 |
| Total Favourable | 5 | 4 |
| Maximum Value | 7 | 7 |
| Weighting (Maximum 50) | 25 | 25 |
| Survey Score | 17.85 | 14.29 |

### Calculation for Survey Question 1:

### (Total Favourable/Maximum Value)*Weighting

(5/7)*25=17.85

### Calculation Survey Question 2:

### (Total Favourable/Maximum Value)*Weighting

(4/7)*25=14.29
In conclusion, the calculated Survey Answers metric=17.85+14.29=32.14

### Gender Fitness Score Calculation:

### Gender Fitness Score=Gender Ratio Score+Survey Answers

68=36+32.14

### Example 2

Meeting with the following composition of participants:

| | |
|---|---|
| Females | 2 |
| Male | 8 |
| Other | 0 |
| Total Team Members | 10 |

### Calculated Females=2

### Calculated Males=8

Calculate the variance from 50% equality.
Percentage of one gender by total (2/10)*100=80
Calculate variance from 50 (balance) IF (80−50>0) then (80−50) else (50−80)=30
Convert the value out of 50 as the maximum score is 50.

50−30=20

### Conclusion: Gender Ratio Score=20

### Survey Questions Example:

| Question # | Question | # Options | Values | Weighting | Start Date | End Date |
|---|---|---|---|---|---|---|
| 1 | Was I given the | 2 | 1 = Yes | 50% | 19 Apr. 2017 | 31 Dec. 2017 |
| | opportunity to | | 0 = No | | | |
| | contribute? | | | | | |
| 2 | Rate your | 5 | 0 = Unfavourable | 20% | 19 Apr. 2017 | 31 Dec. 2017 |
| | experience | | 4 = Favourable | | | |
| 3 | Was my | 2 | 1 = Yes | 30% | 19 Apr. 2017 | 31 Dec. 2017 |
| | contribution | | 0 = No | | | |
| | respected? | | | | | |

For one meeting with 10 invitees which all answered the questions the results were as follows:

| | Q1 | Q2 | Q3 |
|---|---|---|---|
| Invitees 1 | 1 | 1 | 1 |
| Invitees 2 | 1 | 4 | 0 |
| Invitees 3 | 1 | 2 | 1 |
| Invitees 4 | 0 | 0 | 1 |
| Invitees 5 | 0 | 3 | 0 |
| Invitee 6 | 1 | 3 | 1 |
| Invitee 7 | 1 | 3 | 1 |
| Invitee 8 | 1 | 2 | 1 |
| Invitee 9 | 1 | 4 | 0 |
| Invitee 10 | 0 | 0 | 0 |
| Total Favourable | 7 | 22 | 6 |
| Maximum Value | 10 | 40 | 10 |
| Weighting (Maximum 50) | 25 | 10 | 15 |
| Survey Score | 17.5 | 5.5 | 9 |

### Calculation of Survey Question 1:

### (Total Favourable/Maximum Value)*Weighting

(7/10)*25=17.5

### Calculation of Survey Question 2:

### (Total Favourable/Maximum Value)*Weighting

(22/40)*10=5.5

### Calculation of Survey Question 3:

### (Total Favourable/Maximum Value)*Weighting

(6/10)*15=9
In conclusion: Survey Answers=17.5+5.5+9=32

### Gender Fitness Score

### Gender Fitness Score=Gender Ratio Score+Survey Answers 52=20+32

The Gender Fitness Score for the two meetings is determined as an average as follows:

### Total Gender Fitness Scores for all Meetings/Number of Meetings

(68+52)/2

Gender Fitness Score_{TOTAL}=60

With reference to the accompanying drawings, one or more preferred embodiments of the invention perform steps including, capture of email addresses, gender information, departmental details and meeting invitations for a given set of employees; capture of information from a plurality of organisation sites is performed; data capture is made available as near real-time as practical without causing undue system performance or project delivery impact; presenting a “Gender Fitness” scorecard to employees by way of mobile website and/or mobile app; consolidation of input data into a central data store to be made available for use beyond a given meeting.

Further items of information pertaining to the organisation's business or technology deliverables that may be considered useful for inclusion into the ‘Gender Fitness’ scorecard, may include: inclusion of all organisation employees; capturing qualitative feedback via mobile app; extension of input data to include other sources (eg, recruitment & hiring data); detailed analysis over multiple metrics and dimensions. By way of example, the features of this embodiment may be utilised by business and technical teams within an organisation. To accomplish the business objectives of an organisation, the preferred App may be utilised to capture and present information relating to the gender balance of meetings conducted within the organisation, where this information is presented via a website and mobile application for both Android and IOS. In doing so a basic qualitative analysis of gender quality can be gleaned from the invitees to the business meeting.

A block system overview is illustrated in FIG. 3. The system architecture presented within the overview of FIG. 3 is designed to provide extensibility, scalability and reusability. Accordingly, the system of preferred embodiments includes services and components that are transferable and available to any number of organisations. The following guiding principles have been considered in order to maintain this extensibility and portability: Each component delivered must be modular and perform one specific job or action; Applications consume data via API, only from their own data source, an authoritative API, or an authoritative data store; Decoupled integration between services that retrieve information and the source systems that provide that information; An authoritative data store is populated only from true data sources, not from secondary data sources. In this respect, ‘true data sources’ is reference to the systems that are responsible for the system/user input. This information is propagated to downstream systems for said data. In contrast, ‘secondary data sources’ is generally reference to what a system would refer to for data if this is stored within the environment of this system (a copy from the true data source) that is updated from the true data source. True Data Sources' are the systems that are responsible for the system/user input. This information is propagated to downstream systems for said data

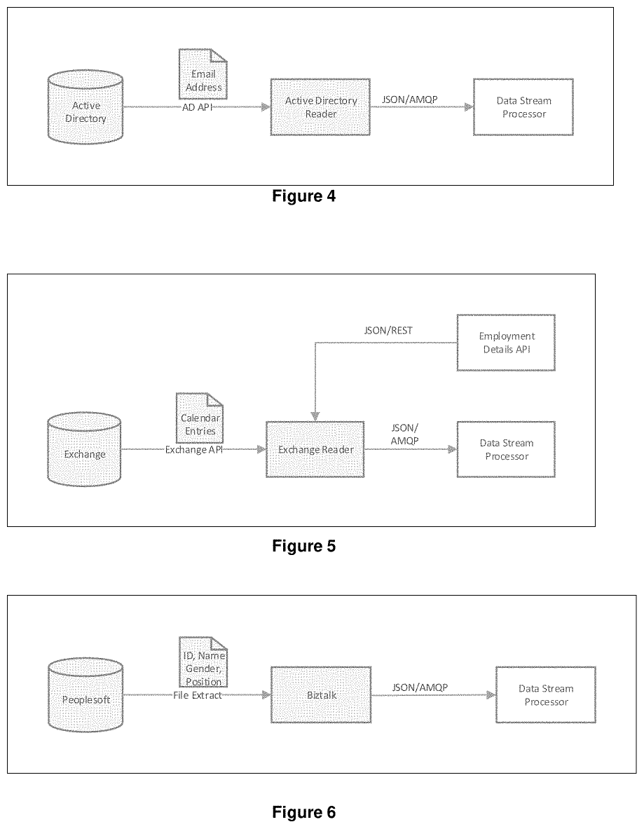

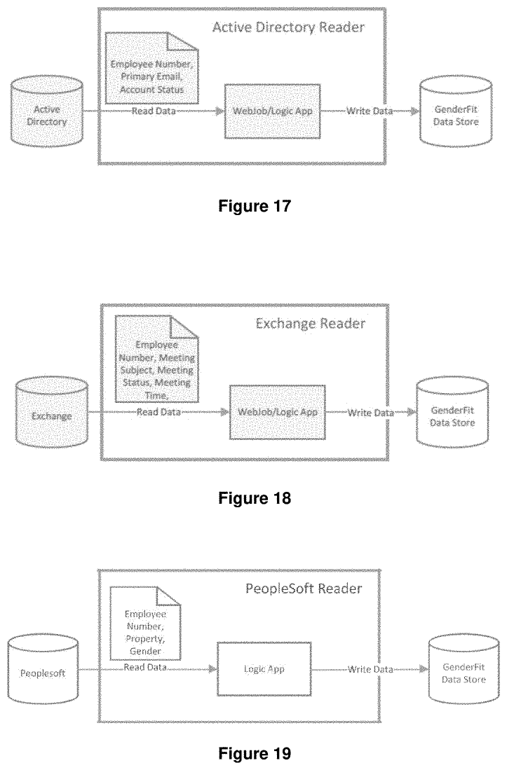

With reference to FIGS. 4 and 17 in a Microsoft™ systems and network environment, an Active Directory reader is configured to retrieve employee number, primary employee email addresses and account status from a true source (ie, Active Directory as shown) and propagate that data to a centralised authoritative source for use of downstream systems, including but not limited to the calculation of a ‘Gender Fitness Scorecard’. The Active Directory reader should run autonomously as a contained application. This is part of the configuration and capability of the technology; the configuration will be to ensure this service runs on a scheduled job and executed autonomously. When user profile data is required from multiple Active Directory domains, a single instance of the Active Directory reader is provided for each domain. Active Directory is the source of truth for authentication services and user profile data. Configuration parameters may include Active Directory containers that need to be queried and polling interval/schedule. A minimum of unnecessary data is published onto the message queue by, for example, using last updated timestamp. This may be derived from the timestamp, message queue name when published from source systems, it will be a simple way to filter messages that are both time relevant and operation relevant. Initial synchronisation will include all fields, syncs thereafter should contain change deltas only, unless full synchronisation is triggered from an action.

The Active Directory reader is dependent on Active Directory instances and on the message queue. No additional dependencies, such as databases, are introduced.

Inputs for the Active Directory reader comprise a local configuration file, which includes runtime parameters including Active Directory connection details, polling interval/schedule, MQ details and any transformation rules. Additionally, the Active Directory of the organisation's sites are input.

The output of the Active Directory reader are a JSON formatted document published onto a RabbitMQ persistent queue, including the following data:
Employee number or ID
Source domain
Primary email address
Active flag
Account status
Retrieval timestamp

Functionally the following applies. Data must be retrieved from all required Active Directory domains. Polling of the Active Directory is at a regular, configurable, interval of no less than once every 24 hours. New employees should have all initial data fields synchronised. Only deltas of changed data should be included in subsequent synchronised processes for existing employees. Data for disabled users must be included in order to capture deactivated accounts. Only the primary email address is required.

With reference to FIGS. 5 and 18 the Exchange reader is configured to retrieve employee calendar information from the source system (i.e., Exchange Server) and propagate that data to a centralised authoritative data store for use by downstream services.

Preferably, a single instance of the Exchange Reader is provided to read data for multiple Exchange Servers. Configuration parameters may include queries for target data sets, timestamps and include the mailboxes that need to be queried and polling interval/schedule. Initial synchronisation may include all fields, syncs thereafter should contain change deltas only, unless full synchronisation is triggered from an action.

The Exchange Reader is dependent on mail servers. Preferably, no additional dependencies, such as additional databases, are introduced. Initial synchronisation may include all identified fields, syncs thereafter should contain meeting relevant fields only. In the event of technical limitations with retrieving large amounts of data from an Exchange Server, the required mailboxes or employee types may be specified in the local configuration file. If the required mailboxes are determined by employee type or level, this information is obtained from the Employment Details API.

Inputs for the Exchange reader comprise the following. Local configuration file, which includes runtime parameters including Exchange server details, polling interval/schedule, exchange data to be captured for calendar entries, Exchange Server using Exchange Web Services. This may include:
Target server configuration (IP Address/Name)
Polling configuration
   Time to execute
   Username and password
Configuration of data to be captured.

An employment details API is utilised for retrieving required email address list from employee type/level or employee ID list.

Outputs for the Exchange reader are in the form of JSON formatted document published into a data store, including the following calendar entry data:
Employee ID
Meeting ID
Meeting subject
Meeting status
Organiser's email address
Invitees (email address, attendance type (required/optional), mailbox typr (mailbox group, external))

Data is retrieved from all relevant Exchange servers. Only the required calendar details for mailboxes specified are retrieved. Preferably, no description data nor attachments are captured. Calendar data should be scheduled near to real-time, otherwise a schedule is determined which meets business requirements. Group addresses must be expanded to individual mailboxes.

Implementations of a HR database information reader is described with reference to FIGS. 6 and 19. The example proprietary HR management system used in the example described is PeopleSoft™. The HR information reader retrieves a subset of employee personal details from the true source (i.e. PeopleSoft HR) and propagates that data to a centralised data store for use by downstream services. The centralised data store may be an unaudited data store. Only information for which PeopleSoft™ is the true source should be propagated through the HR Reader. Configuration parameters include queries for target data sets, timestamps and sync include the property and gender that need to be queried and polling interval/schedule.

### Example One

An employee's internal email address is specified in Active Directory, and then propagated to Peoplesoft™. The true source of email address Active Directory, so the unaudited data store will only have the internal email address populated from Active Directory.

### Example Two

An employee's home email address may usually be initially obtained through their recruitment process and propagated to Peoplesoft™. Once they start employment, Peoplesoft™ is the true source of their home email address, so the unaudited data store will only be populated from Peoplesoft™.

The PeopleSoft™ Reader is dependent on PeopleSoft™ HR configuration. Database tables and fields will need to have entries against time of modification etc. to reduce the volume of data synchronised. Initial synchronisation may include all fields, syncs thereafter should contain change deltas only, unless full synchronisation is triggered from an action. In one alternate form, the solution as presented may be dependent on a BizTalk™ orchestration being modified to add an additional destination for the existing employee details updates, and for BizTalk™ to be able to present the required data on a RabbitMQ queue. Further modified solutions may include BizTalk™ presenting the data via a web service or API.

Inputs for the HR reader may include PeopleSoft™ data from different locations of the organisation.

Outputs of the HR reader are JSON formatted document published including the following data:
Source property, ie location. This is applicable when multiple properties are applied within the organisations structure of ERP (Enterprise Resource Planning) system.
Employee ID
Full name
Gender

For the HR functioning data is retrieved from PeopleSoft™ Database servers. Only data attributes relevant to the metering of the specific demographic balance metric are synchronised (eg Employee ID, Property and Gender). Only changed data in the previous 24 hours should be synchronised. Polling of the PeopleSoft™ database is to be at a regular, configurable, interval of no less than once every 24 hours.

As general points, a number rules are noted here for software implementations of preferred embodiments. It is envisaged that if any HR database indicates a User/employee/manager is on leave then no meetings should be flagged by the preferred embodiments of the invention for that leave period in the Users My Meetings Summary view. Accordingly, no push notifications should be sent during the leave period. An indicative cost of each meeting may be displayed on user devices or recorded centrally by utilising averaged salary information for the meeting attendees. This may be available in HR databases. When a group is invited to a meeting, the individual members within the group are extrapolated and each member is included as a Meeting Invitee. If a meeting is cancelled after import to database, then apply Cancelled Meeting Flag (Y) and, remove from display and exclude from all calculations. In this respect, a default flag would be (N). If a meeting is cancelled, past occurrences of this meeting will not be cancelled in preferred embodiments do that user's scores are not impacted. Only future occurrences will be cancelled. It is noted that the synch service may change future meetings within 2 days of the present date/time. Import private meetings & apply Private Meeting Flag (Y). If a meeting is marked private after import to database, then apply Private Meeting Flag (Y). If returned to public, update Private Meeting Flag to N. In this respect, flag default is N. Users should see all meetings, including those booked on weekends and outside of local standard office hours. Only meetings that have a minimum 1 Meeting Invitee are to be imported. In other words, meeting includes minimum organiser plus one other. Calendar changes are to be reflected in near real time. Users should not see meetings created in the past unless they are recurring meetings (a meeting is considered to have been created in the past if the Created Date/Time is later than the Meeting End Date/Time). In this case, assign Recurring Meeting Flag (Y) and in this respect, flag default is N. Each Meeting is assigned a Unique Meeting ID including each instance of a recurring meeting. When a one-off meeting is changed to a recurring meeting if it's within 14 days of the original meeting creation then the original meeting will be cancelled and replaced with the recurring meeting. Scores for the meeting received in the past 14 days will be impacted. If the original meeting was more than 14 days ago then the old meeting will not be cancelled and a new recurring meeting will be created. If Meeting details are changed/updated they should be overwritten in the database. If changes are made to the Meeting Details, the Last Updated Date/Time is recorded. Preferably, users can see all meeting details: Organiser, Invitees, Room, Meeting Created Date/Time (UTC & local time), Meeting Start and End Date/Time (UTC & local time). If Employee details change in the HR database a new record is created and stamped with and Effective Start Date/Time, Effective End Date/Time and Current Record indicator. Therefore, do not overwrite the existing record. Administrators or certain users can track when a user provided their Survey Response (UTC & local time) and the device they were using. Administrators or certain users can track attendance by Meeting. Where Meeting Invitee indicates that they attended a meeting i.e. selects ‘I Attended’ for Meeting in Gender Fitness, apply Meeting Attendance indicator=Y. If they ‘Did Not Attend’, Meeting Attendance indicator=N. In this respect, indicator default is blank. Import employee leave (all types) information from HR databases (see Data & Reporting Requirements DB1). Example records would be: Unique Employee ID; Leave Start & End Date/Time. If HR database indicates User is on leave, apply Meeting Attendance Flag=N and exclude from view and calculations unless the User has already responded to Survey questions. Also, it is envisaged that the following employee information is imported: Personal details and hierarchy to come from Peoplesoft; Email from AD. Database captures the meeting Show As Status (ie Busy, Tentative, Out of Office) in each User's calendar. An upper limit on the import of meetings should be configurable but generally a limit of 100 attendees for a meeting is to be used. If a meeting was created with both internal and external Meeting Invitees and all internal invitees decline the meeting, this meeting should be deleted from the database. In a preferred embodiment, Meetings shown are only those where the Meeting Organiser has a company email address. As would be appreciated by the person skilled in the art, ‘onboarding’ screens should be displayed upon very first login or major version updates. In preferred embodiments, meeting display order (list or card view) may take the following format: 1. Today section—Meetings are displayed in chronological order by time for Today (local time), and; 2. Meetings Awaiting Feedback & Feedback Received sections—display order is reverse chronological order by date, chronological by time if multiple meetings within a day i.e. 26 June 09:00-10:00, 26 June 10:00-11:00, 25 June 09:00-10:00 etc. Meeting card display may change depending on whether User was Meeting Organiser or Meeting Invitee: If the User was the Meeting Organiser, show “Feedback %” for that meeting. If the User was a Meeting Invitee provide buttons to respond “Attended” or “Did Not Attend”. Once a User has provided feedback for a meeting, remove the Meeting Invitee card from that Users display. Meeting display duration—Meetings Awaiting Feedback section: Meetings are displayed for 14 Days after Meeting End date where Meeting is held on Day 0, unless User has provided meeting feedback (remove from display). On 15th day after Meeting End date, meeting is removed from view so no feedback is able to be provided. Meeting display duration—Feedback Received section: Meetings are displayed for 14 Days after Meeting End date where Meeting is held on Day 0. On 15th day after Meeting End date, meeting is removed from view as no further feedback can be received. Do not display meetings with the following flags: Cancelled Meeting Flag=Y; Private Meeting Flag=Y; Meeting Attendance Flag=N. Meeting display duration—Today Section: Invitee/Attendee cards for Today (local time) are displayed in this section until meeting feedback is provided (then remove from display) end of day local time (move to Meetings Awaiting My Feedback section). Organiser cards are displayed in this section until meeting has ended, then moved to My Feedback section. Rules for displaying a Gender Fitness Arrow on the Home Screen are as follows: If Gender Fitness Score is increasing—up arrow icon, colour=green; If Gender Fitness Score is decreasing—down arrow icon, colour=red; If Gender Fitness Score is unchanged—no icon is displayed. Meeting Organiser is not required to indicate if they attended or asked Survey questions for meetings they created. In embodiments, users cannot provide feedback for future meetings. Users may provide meeting feedback for current meeting 5 minutes prior to meeting end. User can only provide feedback for meetings in the past, from Day 0-14 (Today=Day 0, Yesterday=Day 1 etc). On 15th day after Meeting End date, meeting is removed from view and no further feedback is able to be provided. Meeting Organiser ‘Likes’ can be configured as follows: Meeting Organiser can ‘Like’ their Feedback % only after meeting time has passed, up to the day it is locked and removed from view (15th Day after the meeting); Meeting Organiser can only ‘like’ their own meeting when feedback is between 10%-100%; Meeting Organiser can undo/remove a ‘Like. Meeting Organiser ‘Likes’ can also be configured as follows. When a user ‘likes’ or undoes/removes the ‘like’ on one of their meetings this is tracked, and the following details captured: Unique Meeting ID; Unique Employee ID (Organiser); Date/Time of ‘like’ (UTC & local time); If Like was Applied or Removed; Feedback % at time of Like/Unlike; Device Used (iOS/Android). With regard to data security, the following may be applied: Users can only see data and generate reporting for employees within their organisational structure (ie direct and indirect reports) and; Benchmarking data is only able to be viewed at the aggregate level. Scores are dynamic and will adjust as feedback is received from Day 0-Day 14 (Today=Day 0, Yesterday=Day 1 etc). Scores are finalised from the 15^{th} day after the meeting. If the Meeting Attendance Flag is set=N, exclude User from all calculations. If Meeting Attendance Flag is set=Y, include User in all calculations. If Meeting Attendance Flag is set=blank, include User in Meeting Gender Split Score calculation, exclude User from Meeting Fitness Score calculation, and include User in Percentage of My Attendees Providing Feedback calculation. Only Meetings with 2 or more Meeting Invitees (total 3 Employees) are included in all calculations. In preferred embodiments, if Total Meeting Invitees is X, and X or X−1 invitees didn't attend, this meeting will not count toward Meeting Feedback Score, Meeting Gender Split Score, Gender Fitness Score calculations or Percentage of My Attendees Providing Feedback. Feedback from meetings with 1 Invitee contribute to that meetings ‘Feedback %’ calculation. If Cancelled Meeting Flag=Y do not display and exclude from all calculations. If Private Meeting Flag=Y do not display and exclude from all calculations. Meeting data is only used in calculations of My Progress metrics (Meeting Fitness Score, Gender Split Score and Gender Fitness Score) after the Meeting End date/time has passed. Responses to survey questions once identified should be able to be linked to the respondents' gender. Changes to all employee details (for a Unique Employee ID) should be tracked as they flow through from HR databases, and also changes to employee email addresses should be tracked, so that the responses for a department as at a point in time may be analysed. The length of time between Meeting End Date/Time and Survey Response Date/Time should be viewable or identified so that User Engagement may be analysed.

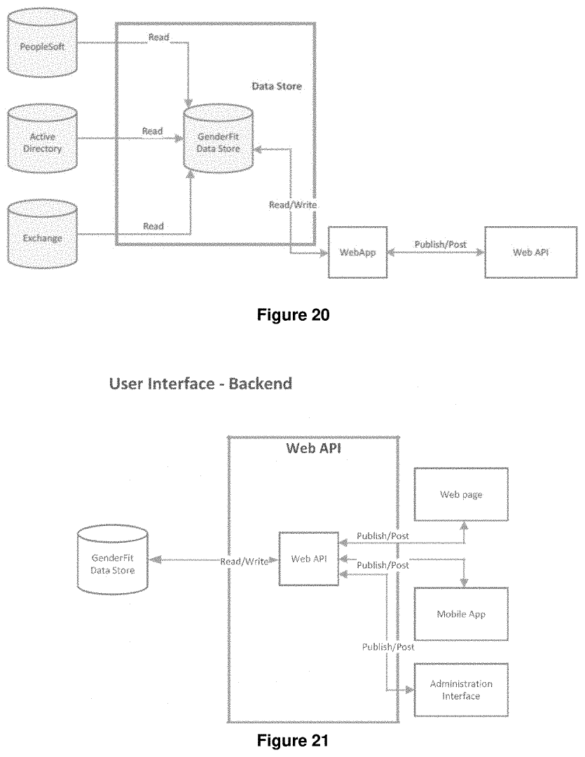

In FIG. 20 a data store is illustrated. The data store can be considered the source of data utilised by a metering algorithm and services that are measuring the demographic, eg gender, metric. It is an accurate representation of data from upstream systems. However, it is not the source of truth for the data contained in Gender Fitness data store excluding any data that is captured as part of the Gender Fitness services (Mobile/Web etc.) In this respect, truthful sources will be the respective systems, such as for example, Email—calendar information, email address etc.; ERP—Employee gender; Directory Services—Authentication services, username and password etc.

Inputs to the data store of FIG. 20 include:
Active Directory data input. For example, employee ID, primary email address, account status, display name
Exchange data input. For example, employee ID, calendar data
PeopleSoft™ data input. For example, employee ID, property, gender Outputs of the data store of FIG. 20 will include:
ODBC (Open db Connectivity) from application services to read and write data to the data store
Logging information

Functional requirements for the data store of FIG. 20 include a database to store structured data. Data will be accessible via APIs created as part of the Gender Fitness services. Configurable tables and structure to accommodate dynamic changes are also provided. Furthermore, encryption of data at disk level is provided. Preferably, this may be provided in the form of the encryption method being a token key which encrypts data on the disk level with every write, data is decrypted with every read using the same keys where a 256-bit AES encryption is used.

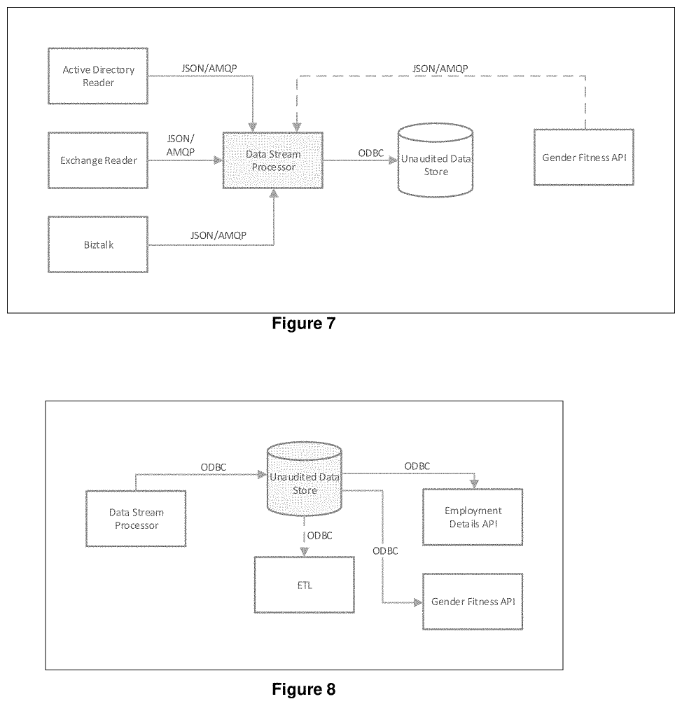

In FIG. 7, a data stream processor is shown. The data stream processor serves as a layer of separation between the source system retrieval and the unaudited data store, reducing the dependencies between those systems. Preferably, the implementation of the data stream processor is on a middleware messaging platform. Alternatively, that may be provided as independent components services. As would be understood by the person skilled in the art, a data stream processor is a technology service which can be configured and implemented to pass on events and triggers in high volume use cases. It is designed to act on and monitor real-time events to notify end points of change or events.

In FIG. 8 an example of an unaudited data store is shown. The unaudited data store may be considered an authoritative source of data that accurately represents data obtained from its true source (ie, source system). The unaudited data store is populated only from a true source, that is via properly governed means. In this sense, the data is populated by a tool which has strict but simple guidelines. The data cannot be manipulated or changed in any way when it is transferred, the data must be in a raw format from the source of truth.

The inputs for the unaudited data store include the following:
Active Directory Data Stream Processor. Supplied information includes Property, Employee ID, primary email address
Exchange Data Stream Processor. Information provided includes Property, Employee ID, calendar entries
Biztalk™ employee orchestration, from Peoplesoft™. Information provided includes Property, Employee ID, name, gender, jobcode, grade, manager ID

Outputs of the unaudited data store may include:
Gender fitness API
Employment details API
ETL (extract, transform and load).

The ETL process is a mechanism used to

Extract—data from a source system by a method which is supported by both the ETL tool and source system.
Transform—data is transformed during through this extract process to be consumable by the target system.
Load—data is loaded in the target system with transformed data which is structured in a format that the target system can consume.

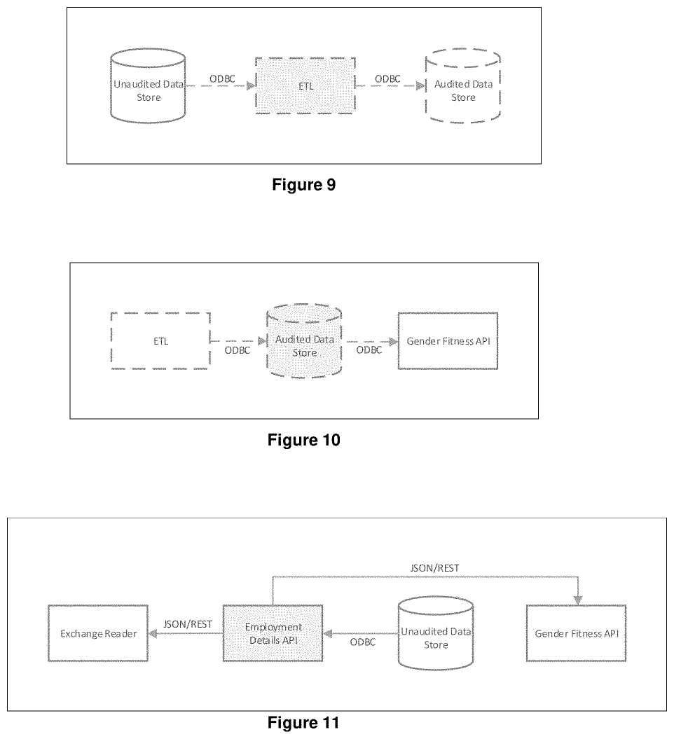

FIG. 9 shows an example ETL process used to populate an audited data store. It does this with data that is already available in the unaudited data store. This may become necessary as demands for presenting data are increased. As the amount, types and extent of data captured around the metering and reporting process increases, the ETL process will be required to transform the unaudited data into a model that is more readily presented for consumption by the app that calculates the scorecard for the demographic and any other dashboards that may be required.

In preferred embodiments team leaders are able to differentiate between data for their direct and indirect reports on the score displayed dashboard. It is also envisaged that team leaders, managers, administrators or other certain users will be able to benchmark scores for team, department, company, industry.

FIG. 10 shows an example audited data store. An audited data store is a repository which contains data that is cleansed and verified in terms of accuracy.

Transformation can occur to structure this data in a readily consumable format. Data principles is applied (data dictionary, relationships, correlation etc.).

FIG. 11 shows the employment details API.

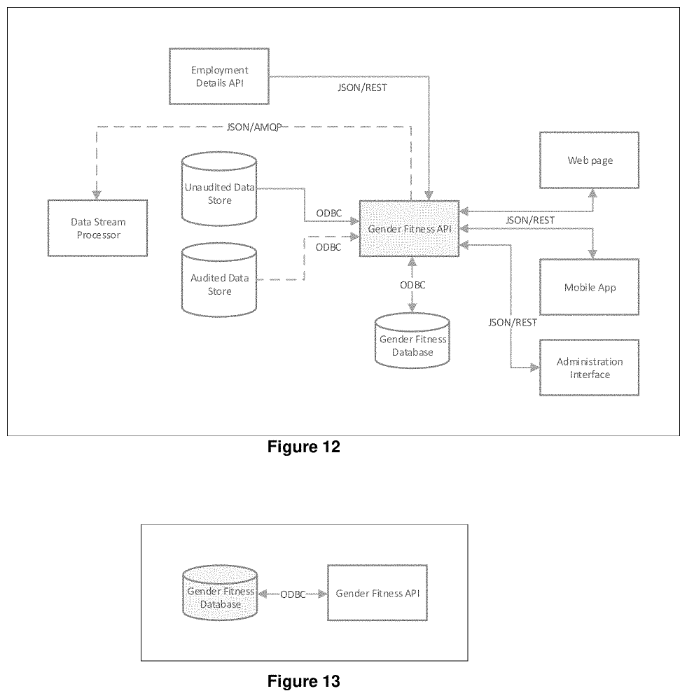

With reference to FIGS. 12 and 21 the main API responsible for facilitating the interfacing between the services providing the metering and reporting functions and procedures is illustrated. The API's role is to publish and post data to and from the data store. This will allow the information in the data store to be easily consumed by approved end points (i.e. Website, Mobile App). API's will enable easy interfacing and communication to systems required to exchange information with the metering and reporting services. Inputs to the main API include:
To read data from data store and publish into API (JSON) format
To capture data inputted from end points (user interfaces) and write data to the data store
Authentication of mobile application calling API's. To restrict the API calls to mobile application only, service account
Authentication of approved users (employees), for both web page and mobile application
Authentication of administration users to the administration portal.

Outputs of the main API comprise:
Consumable API for mobile services.
Consumable API for website services.
Active directory authentication for mobile application users.
Active directory authentication for website users.
Active directory authentication for administration users.

With respect to its functions, the API provides authentication services. The API is responsive and caters for simultaneous requests from approved user interfaces. Only data that has changed should be synchronised. Secure communication mechanisms.

FIG. 13 shows the main API database for the metering and reporting of demographic metrics.

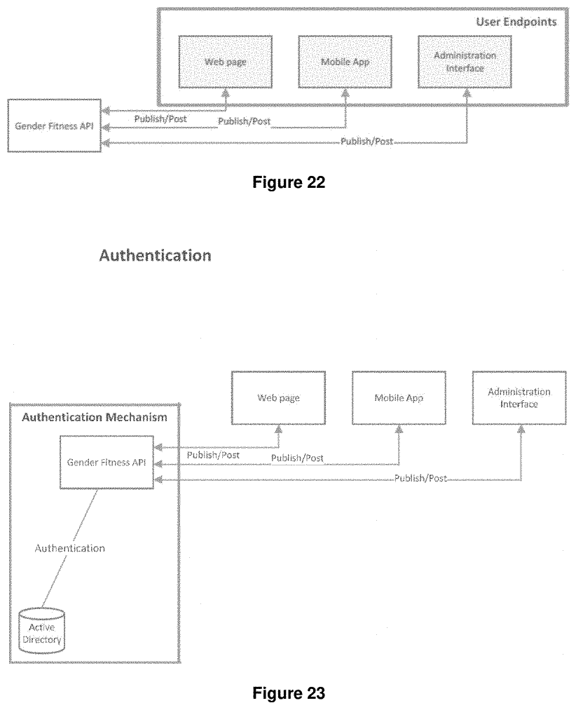

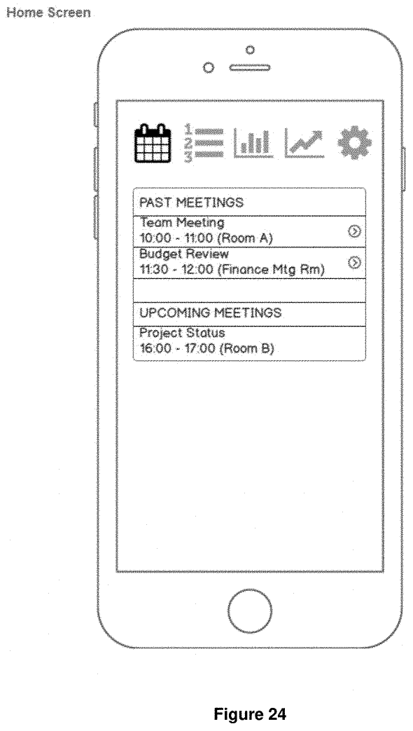

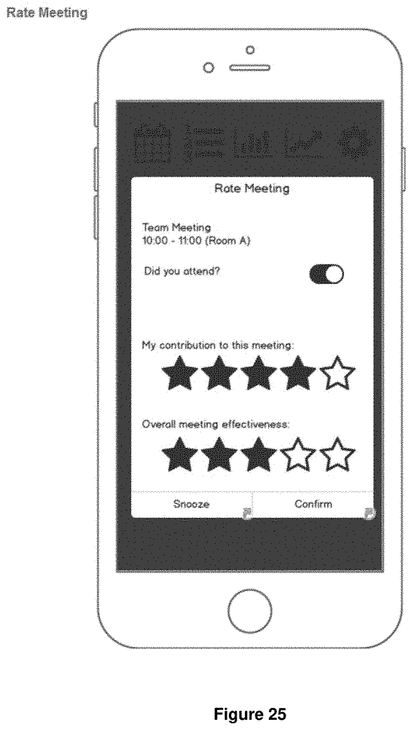

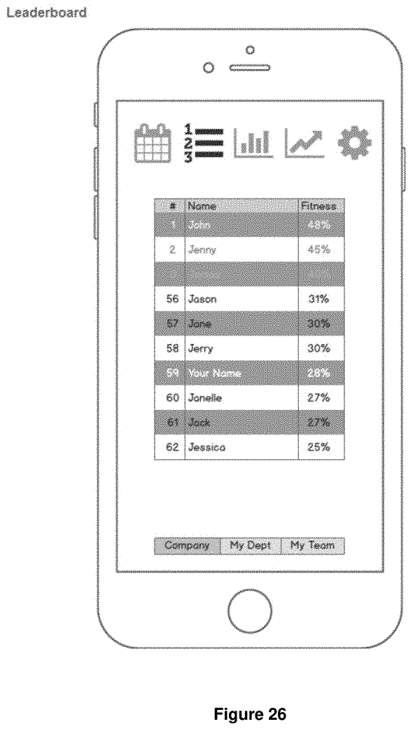

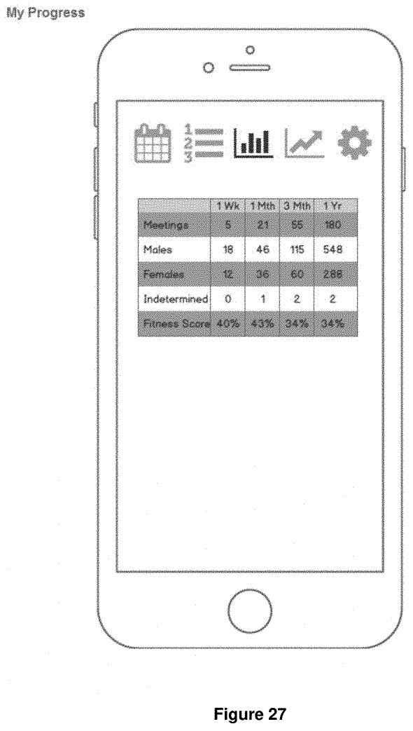

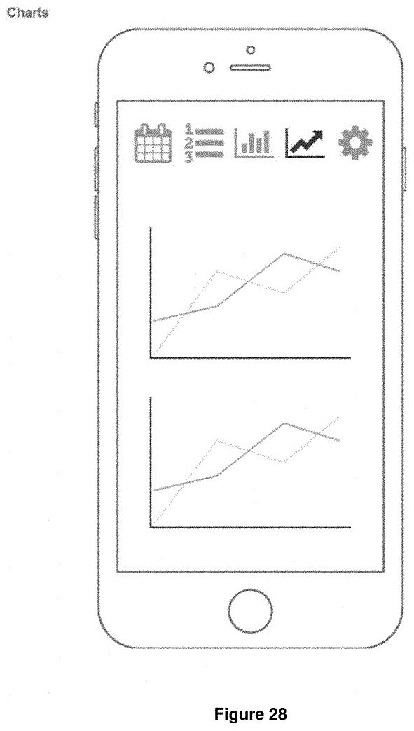

FIGS. 14 and 22 illustrate the user interfaces of the main metering and reporting functions for gender balance. These interfaces are the endpoints of where the users will interact with the technology for Gender Fitness. The user interface provides graphical representation of the data presented from PeopleSoft™, Exchange and Active Directory. Capability for the interfaces should include capturing data that can be stored in the above described data stores.

Inputs for the interfaces may include:
Web interface
Authentication mechanism
Responsive webpage
Encryption in transit
Native mobile application
Graphical interface for users to interact with the data presented and captured via Gender Fitness services.
Administration interface

Outputs for the interfaces include:
Web page to be able to consume APIs created to publish and push data for Gender Fitness.
Mobile application to be able to consume APIs created to publish and push data for Gender Fitness.
Administration web page to be able to consume APIs created to publish and push data for Gender Fitness.
Administration web page will allow for configurable items.

For the functioning of the user interfaces, with respect to a mobile implementation there is employee authentication and graphical display of data. Further, there is mobile platform support for Android™ and iOS support. Chrome™ and IE support is also provided. Secure communication protocols are provided.

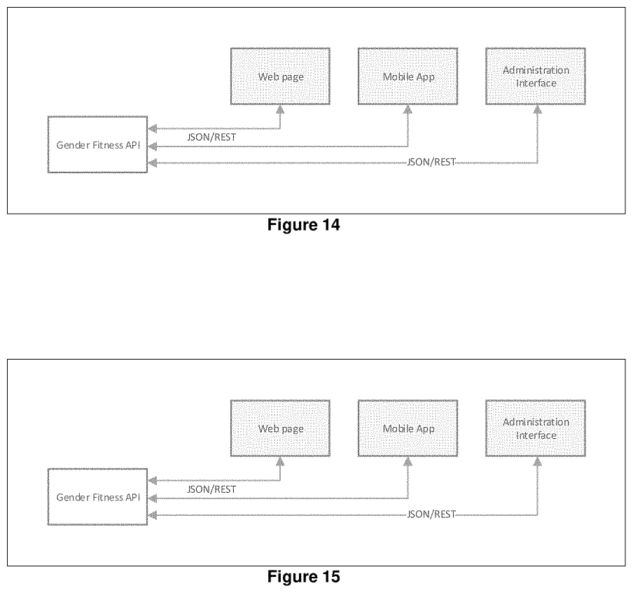

FIG. 15 shows an administration interface.

Data and reporting requirements for preferred embodiments of the invention may include the following.

Employee Data utilised may include:
Unique Employee ID;
Employee First Name;
Employee Last Name;
Employee Gender;
Organizational Structure (all levels). This is preferable;
Reports To Unique Employee ID;
Employee Job Title;
Employee HR Status;
Employee Leave (all types) Start & End Date/Time.

Meeting Data utilised may include:
Unique Meeting ID;
Meeting Subject;
Meeting Room;
Meeting Created Date/Time (UTC & local time);
Meeting Start Date/Time (UTC & local time);
Meeting End Date/Time (UTC & local time);
Meeting Organiser;
Meeting Invitees;
Meeting Show As Status (Busy, Tentative, Out of Office);
Recurring Meeting Flag;
Cancelled Meeting Flag;
Private Meeting Flag;
Meeting Organiser Likes (Date/Time Applied or Removed);
Meeting Response Date/Time (UTC & local time). This is the time at which the Meeting Attendee accepted the meeting, not the response to the question in Gender Fitness survey.

Active Directory data that is utilised may include:
Unique Employee ID
Employee Email Address

Data utilised by meeting for calculation of scores in accordance with preferred embodiments of the invention may include:
Unique Meeting ID
Meeting Feedback Score
Gender Split Score
Gender Fitness Score
Total Males
Total Females
Total Other
Total Meeting Attendees
Total Respondents by Gender (Male, Female, Other)

Data utilised in survey responses for calculation of scores in accordance with preferred embodiments of the invention may include:
Unique Employee ID
Unique Meeting ID
Survey Response Date/Time (UTC & local time)
Meeting Attendance Flag (Y/N)
Meeting Question ID

Usage data that can be monitored in preferred embodiments may include:
Unique Employee ID
Session Login (UTC & local time)
Session Logout (UTC & local time)
Session Timeout (UTC & local time)
Device Type (desktop, tablet, phone)
Device ID
Platform type (iOS/Android)

The above noted usage data also form the required fields in the EmployeeActivity and EmployeeActivityHistory tables.

Push notifications may include one or a combination of:
Unique Employee ID
Push Date/Time (UTC & local time)
Push Message ID
Push Message Type
Push Message Detail

With respect to user engagement in preferred embodiments, as would be appreciated by the person skilled in the art, push notifications may be employed and these may be embodied in the following forms.

For user behaviour based usage management, the following may be utilised.

With no successful log in for an initial period, eg 8 days, & meeting surveys unanswered, the following message may be pushed: “We noticed you haven't logged in for a while FIRSTNAME. Your meeting feedback is valuable. Please make time to log in.”

As a rule, with no successful log in for a second period, eg 14 days, & meeting surveys unanswered, the following message may be pushed to a user/users: “We noticed you haven't logged in for a while FIRSTNAME. Your meeting feedback is valuable. Please make time to log in.”

With no successful log in for a third period, eg 30 days, & meeting surveys unanswered, the following message may be pushed: “We noticed you haven't logged in for a while FIRSTNAME. Your meeting feedback is valuable. Please make time to log in.”

With no successful log in for a fourth period, eg 31 days, & meeting surveys unanswered, the following message may be pushed: “FIRSTNAME, it's been over a month since you logged in to check your score and provide meeting feedback. Your contribution will help Crown become more gender fit. Please make time or let us know your thoughts.”

For early adoption of users of the system the following may be utilised in a time basis.

Upon a 2nd successful log in and answered meeting survey, the following message may be pushed: “Firstname, looks like you've got the hang of things on the Gender Fitness app. Thanks for logging in. Check out the Info screen for any questions you have.”

At 4th successful log in, the following message may be pushed: “Firstname, keep an eye on your Gender fitness score over time on the MY PROGRESS screen. Click the score to see your charts”

At 5 days post first log in & with an Answered meeting survey I Feedback based on meetings that the user has organised have been answered, so the following message may be pushed: “FIRSTNAME, colleagues that attended your meetings have recently answered your meeting survey. Why not log in to check out how your gender fitness score is going?′

With an increase in Gender Fitness score by 5-10 points, the following message may be pushed: “FIRSTNAME, congratulations. We've noticed an increase in your Gender Fitness score. Log in to check your progress over time on the MY PROGRESS screen.”

In tactical use, some ad hoc notification may be utilised, as follows.

“Firstname, welcome. We are delighted to launch Gender Fitness to Crown. This is 1 of many steps we hope to take to promote gender equity at Crown. Thanks for being part of it.”

“We've just launched the Gender Fitness leaderboard. Log in now FIRSTNAME to see your score vs your department average.”

In further embodiments of the invention, a gamification of the system can be employed to enhance the user uptake and experience. Users may want the ability to compare their scores to those of their department and the organisation, as a whole. Managers may also want the ability see how their team is performing, and to be able to encourage staff if engagement is low. Further, users may want the ability to see whether they are making a difference. These wants from users, managers etc, present an opportunity to gamify certain embodiments of the invention.

As would be appreciated by the person skilled in the art, gamification is the process of taking some process that already exists, for example, a website, an enterprise application, or an online community, and integrating game mechanics into it to motivate participation, engagement, and loyalty. Gamification of such processes takes the data-driven techniques that game designers use to engage players, and applies them to non-game experiences to motivate actions that add value to the business process(es).

By way of example, embodiments of the present invention may employ displays for users on their mobile devices that encompass, the department that has had the biggest average score increase in the previous month, ie a ‘most improved department’. The department that has the highest percentage of members who have logged in and provided feedback in the previous month may be awarded as ‘most engaged department’. The department that has the highest percentage of meeting feedback received in the previous month may be awarded as ‘the department with most feedback’. Typical gamification may envisage, users being able to compare their score to the scores of their department and the organisation in the My Progress display. Users can earn achievements working with their department. Further, Users can see how they are tracking within their department, and managers can see how their direct reports are tracking. A dashboard display on mobile devices implements these achievements and trackings.

Feedback may be provided through the use of self-updating dashboards that display real-time trends relating to individuals, teams, departments and organisations. As data is ingested by the application of preferred embodiments appropriate notifications can be sent to organisers and invitees alike to view these feedback dashboards. It is expected that the dashboards may influence an employee's subsequent meetings. It is possible that a participant's behavior may be influenced hourly. The analysis of the effectiveness of these notifications may be used to refine notification timing and content while ensuring a given dashboard contains the most relevant data and trends.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

The following sections I-VII provide a guide to interpreting the present specification.

### I. Terms

The term “product” means any machine, manufacture and/or composition of matter, unless expressly specified otherwise.

The term “organisation” should be taken with its plain meaning. In addition, the term is to be taken as including but not limited to an organized group of people with a particular purpose, such as a club, charity, association, corporation, business or government department.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology Are Not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically, a processor (e.g., one or more microprocessors, one or more micro-controllers, one or more digital signal processors) will receive instructions (e.g., from a memory or like device), and execute those instructions, thereby performing one or more processes defined by those instructions.

A “processor” means one or more microprocessors, central processing units (CPUs), computing devices, micro-controllers, digital signal processors, or like devices or any combination thereof.

Thus, a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fibre optics, including the wires that comprise a system bus coupled to the processor. Transmission media may include or convey acoustic waves, light waves and electromagnetic emissions, such as those generated during radio frequency (RF) and infra-red (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus, a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviours of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralised authority may not be necessary or desirable. For example, the present invention may, in an embodiment, be practised on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

1. A method of metering and reporting on the compliance of an organisation to government, corporate and/or legal requirements by way of determining a demographic measure of an organisation/business activity, process or function wherein the business activity, process or function comprises a plurality of active participants where each active participant carries at least one uniquely identifiable mobile communications device, the method comprising the steps of:
accessing a personal organisation database that is in operative communication with the mobile communications device of at least one or each participant and extracting calendar and/or scheduling information on at least one or each participant from an email service account of respective participants from the database;
accessing a centralised human resource database of demographic information on respective participants;
correlating the personal organisation database records with the demographic information;
generating a score for one or a combination of a participant; a meeting; a manager; a department; an organisation;
reporting the generated score corresponding to a participation metric for the business process or function based on the correlated records and information of each participant;
displaying the reported metric of one or a combination of participants on at least one of the mobile communication devices.

2. A method of metering and reporting on the demographic balance of an organisation, the method comprising:
extracting electronic mail service account information of the organisation;
extracting calendar and/or scheduling information from the electronic mail service;
extracting personal demographic information from a HR database associated with the organisation;
extracting survey data from end point users associated with the extracted personal demographic information;
processing the extracted information
storing the processed information in a first data store
communicating one or a combination of the processed and stored information with at least one or more of the end point users via at least one API;
further processing the communicated information by determining one or a combination of scores;
notifying end point terminals and/or end point users of one or a combination of the determined scores.

3. The method of claim 1 wherein one or more of the extracted electronic mail service account information and the calendar and/or scheduling information corresponds to a selected number of individuals employed with the organisation.

4. Apparatus adapted to meter and report on the demographic balance of an organisation, said apparatus comprising:
processor means adapted to operate in accordance with a predetermined instruction set,
said apparatus, in conjunction with said instruction set, being adapted to perform one or a combination of the method steps as claimed in claim 1.

5. Apparatus adapted to meter and report on the demographic balance of an organisation, said apparatus comprising:
processor means adapted to operate in accordance with a predetermined instruction set,
said apparatus, in conjunction with said instruction set, being adapted to perform one or a combination of the method steps as claimed in claim 2.

6. Apparatus adapted to meter and report on the demographic balance of an organisation, said apparatus comprising:
processor means adapted to operate in accordance with a predetermined instruction set,
said apparatus, in conjunction with said instruction set, being adapted to perform one or a combination of the method steps as claimed in claim 3.

7. A computer program product comprising:
a computer usable medium having computer readable program code and computer readable system code embodied on said medium for metering and reporting on the demographic balance of an organisation within a data processing system, said computer program product comprising:
computer readable code within said computer usable medium for performing one or a combination of the method steps as claimed in claim 1.

8. A computer program product comprising:
a computer usable medium having computer readable program code and computer readable system code embodied on said medium for metering and reporting on the demographic balance of an organisation within a data processing system, said computer program product comprising:
computer readable code within said computer usable medium for performing one or a combination of the method steps as claimed in claim 2.

9. A computer program product comprising:
a computer usable medium having computer readable program code and computer readable system code embodied on said medium for metering and reporting on the demographic balance of an organisation within a data processing system, said computer program product comprising:
computer readable code within said computer usable medium for performing one or a combination of the method steps as claimed in claim 3.
